(19) United States
(12) Patent Application Publication
(10) Pub. No.: US 2018/0246987 A1
(43) Pub. Date: Aug. 30, 2018

(54) GRAPH DATABASE MANAGEMENT

(71) Applicant: ENTIT Software LLC, Sunnyvale, CA (US)

(72) Inventors: Mahashweta Das, Palo Alto, CA (US); Alkiviadis Simitsis, Palo Alto, CA (US); William K. Wilkinson, Palo Alto, CA (US)

(73) Assignee: ENTIT Software LLC, Sunnyvale, CA (US)

(21) Appl. No.: 15/757,178

(22) PCT Filed: Sep. 4, 2015
(86) PCT No.: PCT/US2015/048562

§ 371 Date: Mar. 2, 2018

(51) Int. Cl. G06F 17/30

(52) U.S. Cl. CPC G06F 17/30958; G06F 17/30595; G06F 17/30002

(57) ABSTRACT

Examples for graph database management comprise a graph database system including a graph processor engine to receive a graph database update from an application, a graph navigation query engine to access a real-time graph and process the graph database update on the real-time graph, and a synchronization engine to extract changes from the real-time graph and process the changes to a derived graph view and to a historical graph. Examples for managing a graph database also include receiving a graph query, determining a graph query type, and in the event that the graph query type is a navigational short query type, accessing a real-time graph on a graph navigation query engine and processing the navigation short query, and in the event that the graph query type is an analytical long query type, accessing a historical graph on a graph analytic query engine and processing the analytical long query.

### BACKGROUND

Computing systems, devices, and electronic components may access, store, process, or communicate with a database or databases. A database may store data or information in various formats, models, structures, or systems, such as in a relational database system or a graph database structure. Users or processes may access or query the databases to or retrieve data in a database, or to update or manipulate data in a database.

### BRIEF DESCRIPTION OF THE DRAWINGS

The following detailed description references the drawings, wherein:

FIG. 1 is a block diagram of a system to manage a graph database, according to an example;

FIG. 2 is a flowchart of processing updates on a graph database, according to an example;

FIG. 3 is a flowchart of processing queries on a graph database, according to an example;

FIG. 4 is a flowchart of determining a graph query type, according to an example; and

FIG. 5 is a block diagram of a system to manage a graph database, according to an example.

### DETAILED DESCRIPTION

Various examples described below provide for managing a graph database. In an example, a graph database system includes a graph processor engine to receive a graph database update from an application, a graph navigation query engine to access a real-time graph and process the graph database update on the real-time graph, and a synchronization engine to extract changes from the real-time graph and process the changes to a derived graph view and to a historical graph. Examples for managing a graph database also include receiving a graph query, determining a graph query type, and in the event that the graph query type is a navigational short query type, accessing a real-time graph on a graph navigation query engine and processing the navigation short query, and in the event that the graph query type is an analytical long query type, accessing a historical graph on a graph analytic query engine and processing the analytical long query.

As the amount of information stored on computing devices has continued to expand, companies, organizations, and information technology departments have adopted new technologies to accommodate the increased size and complexity of data sets, often referred to as big data. Traditional data processing or database storage systems and techniques such as relational databases or relational database management systems (“RDBMS”), which rely on a relational model and/or a rigid schema, may not be ideal for scaling to big data sets. Similarly, such databases may not be ideal or optimized for handling certain data, such as associative data sets.

Organizations may employ a graph database to collect, store, query, and/or analyze all or a subset of the organization's data, and in particular large data sets. A graph database may be employed within an organization alone, in combination with other graph databases, or in combination with relational databases or other types of databases.

A graph database may process different types of queries or requests, such as navigational engines including navigational computations and reachability queries, or analytical engines including analytical computations and iterative processing. A navigational query may, in an example, access and update a small portion of a graph to return a real-time response, while an analytical query may access a large fraction of the graph. Graph databases may be specialized, tailored, or “tuned” for a particular type of workload, query, or algorithm, such as for navigational queries, analytical queries, or other query types. [0M] In such examples, a graph database tuned for navigational queries may comprise internal data structures designed for high throughput and access to a small portion of a graph, and may not perform well with analytical queries. Conversely, graph databases tuned for analytical queries may assume an immutable graph which enables the use of data structures to index and compress the graph so that large portions of the graph can be processed quickly, minimizing the computational resources available to process navigational queries.

Accordingly, graph databases or graph database systems may struggle to perform in a mixed workload environment, e.g., a workload comprising both navigational and analytical queries submitted concurrently to a graph database. Organizations may also need to run and maintain two or more systems to support such an environment including real-time graphs, historical graphs (e.g., graphs that reflect the graph at a previous point in time), and/or derived graphs (or “views”, e.g., graphs used to support an application-specific purpose, such as customer segmentation or fraud detection based on another graph) for particular applications.

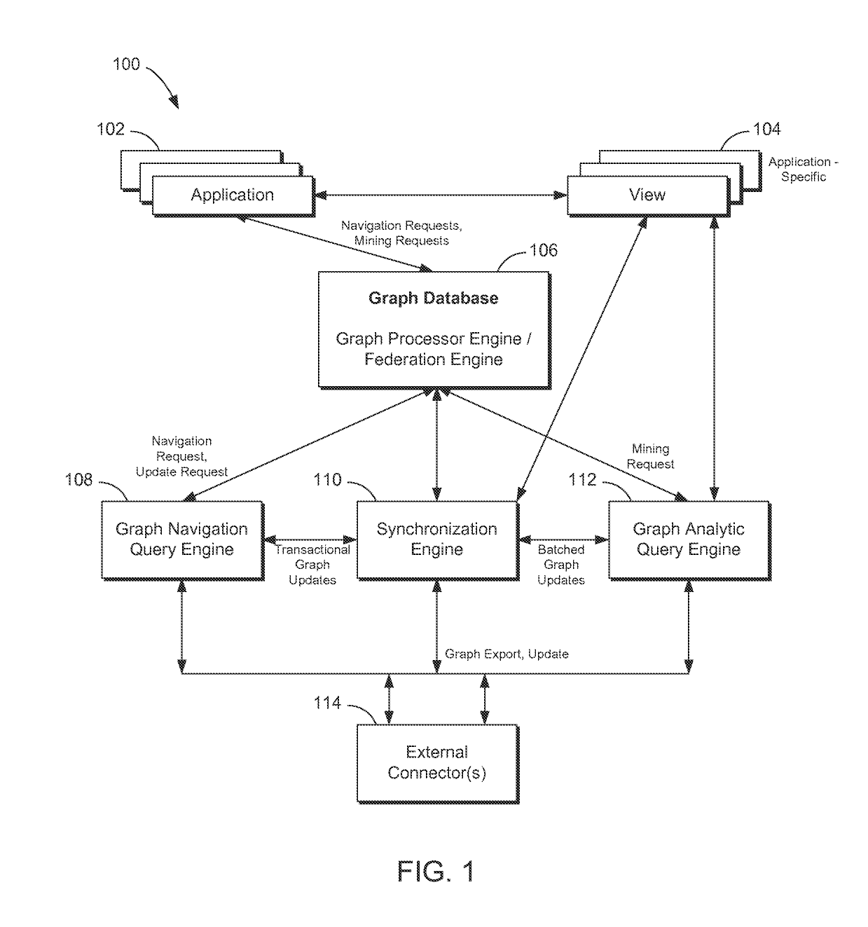

FIG. 1 is a block diagram of a system to manage a graph database, according to an example. FIG. 1 may be referred to as graph database environment 100 or mixed-workload environment.

In the example of FIG. 1, a graph database 106 in graph database environment 100 may comprise a processing engine for collecting and/or storing data, and for executing queries, updates, requests, and/or transactions. The graph database may be any database type that employs graph structures to store data using, for example, edges, vertices, and/or properties to represent and/or store data. As discussed below in more detail, graph database 106 may comprise a hybrid infrastructure with multiple engines and a federation engine (or “layer”) to interface the engines to applications though a single application programming interface.

The graph database 106 may reside in a data center, cloud service, or virtualized server infrastructure (hereinafter “data center”), which may refer to a collection of servers and other computing devices that may be on-site, off-site, private, public, co-located, or located across a geographic area or areas. A data center may comprise or communicate with computing devices such as servers, blade enclosures, workstations, desktop computers, laptops or notebook computers, point of sale devices, tablet computers, mobile phones, smart devices, or any other processing device or equipment including a processing resource. In examples described herein, a processing resource may include, for example, one processor or multiple processors included in a single computing device or distributed across multiple computing devices.

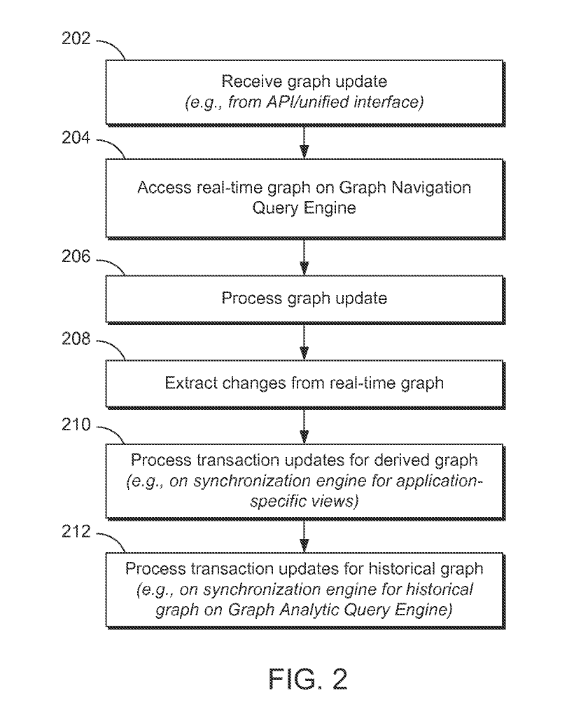

In the example of FIG. 1, the graph database 106 may reside on a computing device that includes a processing resource and a machine-readable storage medium comprising or encoded with instructions executable by the processing resource, as discussed below in more detail with respect to FIGS. 2-5. In some examples, the instructions may be implemented as engines or circuitry comprising any combination of hardware and programming to implement the functionalities of the engines or circuitry, as described below.

Graph database 106 may receive queries or updates from applications 102, which may be applications, processes, tools, scripts, or other engines for purposes of communicating with graph database 106. The queries received from application 102 may be navigational or “short” queries that access a small portion of a graph stored on graph database 106 using requests such as nearest neighbor, shortest path, or other requests that access only a few vertices and/or edges of a graph. The queries received from application 102 may also be analytical or “long” queries that access a large portion of a graph stored on graph database 106 using requests such as a page rank or connected component. In some examples, navigational queries may be executed against a real-time, active, current, or “live” graph, while analytical queries may be executed against a historical graph.

Graph database 106 may comprise or communicate with an engine or engines for executing or processing queries. In an example, an engine may be tuned or adapted to a specific type of query. For example, graph navigation query engine 103 may be tuned for executing navigation or short queries, as discussed above, while graph analytic query engine 112 may be tuned for executing analytical or long queries, as discussed above. In such examples, e.g., in examples of mixed concurrent workloads where graph database 106 may receive queries of varying types, graph database 106 may include an engine for determining which of the query engines to submit a query. In such examples, graph database 106 may include or be coupled to a federation engine or layer to present a hybrid system as a single, unified interface to the applications 102.

Graph database 106 may also comprise a synchronization engine 110 to synchronize the graphs of graph navigation query engine 108, which may access or comprise a real-time graph or graphs, with graph analytic query engine 112, which may access or comprise a historical graph or graphs. Synchronization may occur in batch, periodically, and/or may be transactionally consistent.

Synchronization engine 110 may also enable application-specific views 104 by updating views following an update to an underlying or base graph, such as a view of a particular customer segmentation or other subset or view of data. Application-specific views or models 104 may be derived by analytic queries over the historical graph. These views may be sub-graphs or may be some alternative data structure derived from the graph (e.g., a key-value store). An application may create such a view for more efficient processing of application requests rather than querying the graph database. These views may be, effectively, cached data. As such, they may be informed of updates to the underlying graph by synchronization engine 110 or the entire view may be periodically refreshed by again querying the analytic graph.

Graph database environment 100 may also include external connectors 114, which may be connectors to external systems, processes, or databases, such as a connector to a relational database, legacy system, or other system for ingesting data or exporting data. For example, a relational database may be updated with changes to a graph database via an external connector 114.

In the example of FIG. 1, graph database 106, engines 108, 110, and 112, applications 102, views 104, and external connectors 114 may be directly coupled or communicate directly, or may communicate over a network. A network may be a local network, virtual network, private network, public network, or other wired or wireless communications network accessible by a user or users, servers, or other components. As used herein, a network or computer network may include, for example, a local area network (LAN), a wireless local area network (WLAN), a virtual private network (VPN), the Internet, a cellular network, or a combination thereof.

FIG. 2 is a flowchart of processing updates on a graph database, according to an example.

In block 200, an update is received from, e.g., application 102, which may be an application, process, tool, script, or other engine for purposes of communicating with graph database 106. In the example of FIG. 2, the update is received at a graph processor engine of graph database 106, which may be part of a federation engine or layer and/or application programming interface to provide a unified interface to users and/or applications. The update may be, for example, an instruction to insert a graph edge, delete a graph node, add or modify a property, or otherwise update the graph.

In block 204, a real-time graph is accessed via an engine tuned or configured for a navigational query, e.g., graph navigation query engine 108.

In block 206, the update query is processed on the real-time graph. For example, a graph edge may be inserted, a node may be deleted, or another operation or operations may be performed.

In block 208, changes applied to the real-time graph are extracted. For example, synchronization engine 110 may determine which changes were applied to the real-time graph since the last synchronization.

In block 210, the extracted changes are updated onto a derived graph. In an example, a synchronization engine, e.g., synchronization engine 110, may update a derived graph based on the updates extracted from the real-time graph in block 208. The derived graph may be updated in batch, periodically, and/or may be transactionally consistent. In some examples, the derived graph is used as the basis for application-specific views, e.g., views 104.

In block 212, the extracted changes are updated onto a historical graph. In an example, a synchronization engine, e.g., synchronization engine 110, may update a historical graph via an engine, e.g., graph analytic query engine 112, based on the updates extracted from the real-time graph in block 208.

In some examples, the flow of FIG. 2 may also comprise processing the extracted changes through external connectors. For example, changes to a graph database 106 may be propagated to databases or other data stores or legacy systems through external connectors 114.

In the event that an analytical query executed against a historical graph requires the most recent data, such data may be retrieved on-demand from the real-time or active graph. In one example, analytical query engine 112 may communicate with graph database 106 to request a batch update from graph navigation query engine 108 via synchronization engine 110.

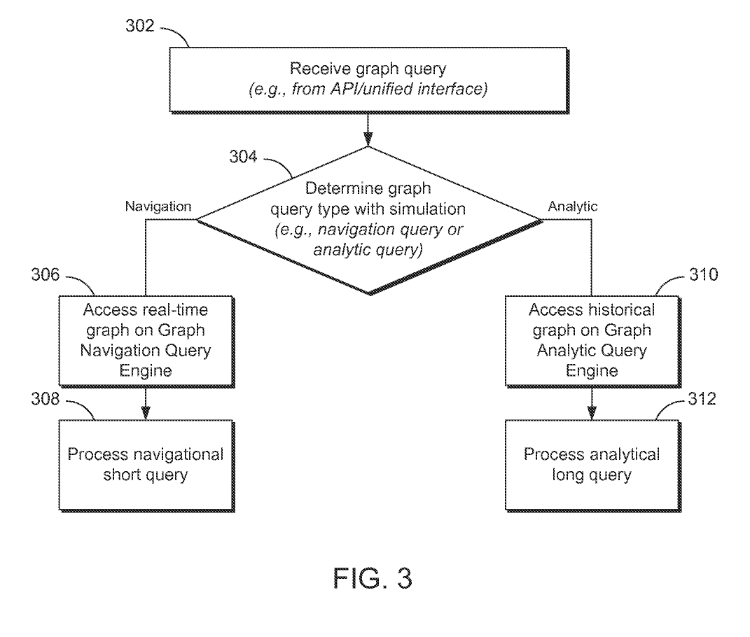

FIG. 3 is a flowchart of processing queries on a graph database, according to an example.

In block 302, a query is received from, e.g., application 102, which may be an application, process, tool, script, or other engine for purposes of communicating with graph database 106. In the example of FIG. 3, the query is received at a graph processor engine of graph database 106, which may be part of a federation engine or layer and/or application programming interface to provide a unified interface to users and/or applications.

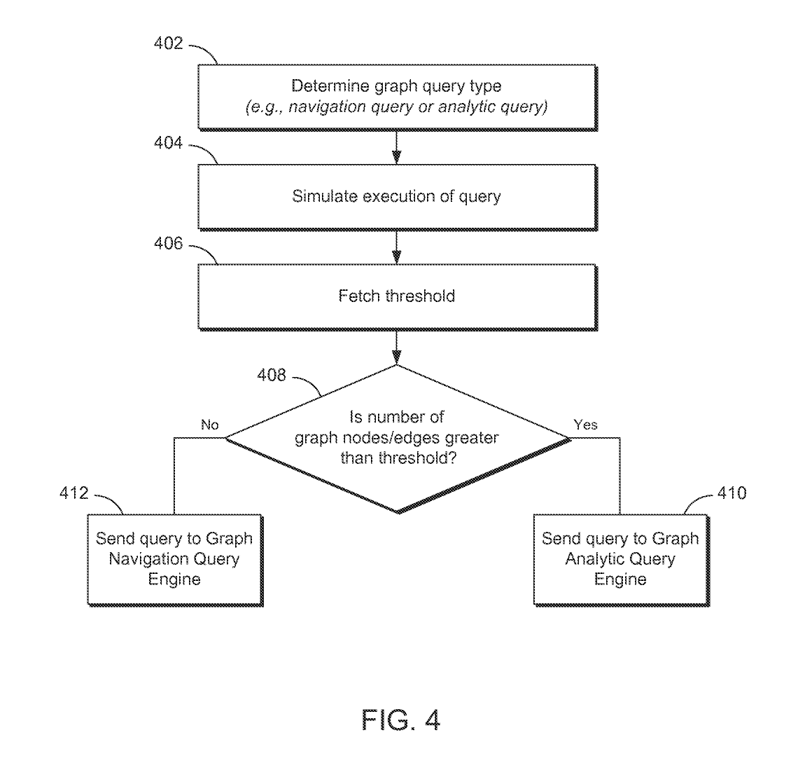

In block 304, a determination is made as to whether the query is a navigational-type query or an analytical-type query. Such a determination may be made, for example, by way of simulating execution of the query, as discussed below in more detail with respect to FIG. 4. In other examples, a determination may be made based on a tag accompanying a graph request indicating a query category, e.g., navigational or analytical. In other examples, the identity of the requestor may be used to make a determination. For example, a determination may be based on a rule or policy that a first application is configured to send navigational requests, while a second application is configured to send analytical requests. In yet other examples, the query may be parsed to determine its type.

In block 306, if a determination is made that the query is a navigational query, a real-time graph is accessed via an engine tuned or configured for a navigational query, e.g., graph navigation query engine 108. In block 308, the navigational query is processed, e.g., a short query is processed, against the real-time graph.

In block 310, if a determination is made that the query is an analytical query, a historical graph is accessed via an engine tuned or configured for an analytical query, e.g., graph analytic query engine 112. In block 312, the analytical query is processed, e.g., a long query (or “mining query”) is processed, against the historical graph.

FIG. 4 is a flowchart of determining a graph query type, according to an example.

In block 402, the process of determining a graph query type is commenced. Block 402 may be, in some examples, an extension of block 304 of FIG. 3.

In block 404, execution of the query is simulated. Simulation of the query executing may indicate or estimate the proportion of graph nodes accessed by the query, which may indicate whether a query is a navigational query or an analytical query.

In block 406, a threshold is fetched. The threshold may indicate, in some examples, a number of nodes or edges in a graph. If the threshold is exceeded, a query may be, or may be likely to be, an analytical query that is likely to access a large number of nodes or edges in a graph. If the threshold is not exceeded, the query may be, or may be likely to be, a navigational query.

In block 408, a determination is made as to whether the threshold is exceeded. The determination may be a calculation as to whether the number or proportion of nodes is less than or greater than the threshold.

In block 410, if the threshold is exceeded, the query may be classified as an analytical or long query. In such examples, the query may be sent to a graph analytic query engine.

In block 412, if the threshold is not exceeded, the query may be classified as a navigational or short query. In such examples, the query may be sent to a graph navigation query engine.

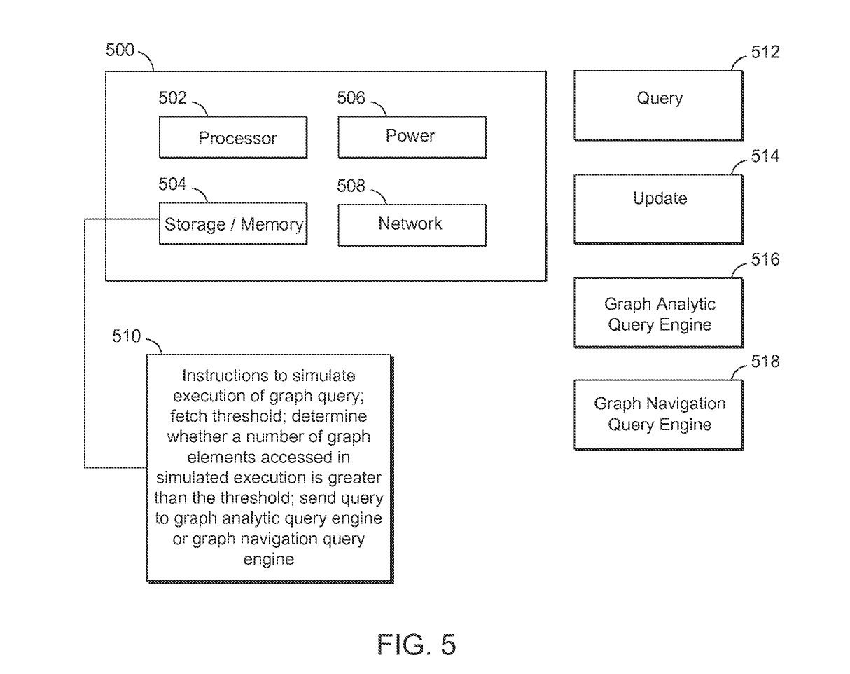

FIG. 5 is a block diagram of a system to manage a graph database, according to an example.

The computing system 500 of FIG. 5 may comprise a processing resource or processor 502. As used herein, a processing resource may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a machine-readable storage medium, or a combination thereof. Processing resource 502 may fetch, decode, and execute instructions, e.g., instructions 510, stored on memory or storage medium 504 to perform the functionalities described herein. In examples, the functionalities of any of the instructions of storage medium 504 may be implemented in the form of electronic circuitry, in the form of executable instructions encoded on a machine-readable storage medium, or a combination thereof.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a hard drive, a solid state drive, any type of storage disc or optical disc, and the like, or a combination thereof. Further, any machine-readable storage medium described herein may be non-transitory.

System 500 may also include persistent storage and/or memory. In some examples, persistent storage may be implemented by at least one non-volatile machine-readable storage medium, as described herein, and may be memory utilized by system 500. In some examples, a memory may temporarily store data portions while performing processing operations on them, such as for managing a graph database.

In examples described herein, a machine-readable storage medium or media is part of an article or article of manufacture. An article or article of manufacture may refer to any manufactured single component or multiple components. The storage medium may be located either in the computing device executing the machine-readable instructions, or remote from but accessible to the computing device (e.g., via a computer network) for execution.

In some examples, instructions 510 may be part of an installation package that, when installed, may be executed by processing resource 502 to implement the functionalities described herein in relation to instructions 510. In such examples, storage medium 504 may be a portable medium or flash drive, or a memory maintained by a server from which the installation package can be downloaded and installed. In other examples, instructions 510 may be part of an application, applications, or component(s) already installed on a computing device including a processing resource, e.g., a computing device running any of the components of graph database environment 100 of FIG. 1.

System 500 may also include a power source 506 and a network interface device 508, as described above, which may receive data such as data 512-514, e.g., via direct connection or a network, and/or which may communicate with an engine such as engines 516 and 518.

The engine comprising instructions in or on the memory or machine-readable storage of system 500 may comprise an engine 510, which may comprise the methods of FIG. 2, 3, or 4. For example, in the engine of block 510, the instructions may simulate execution of a graph query, fetch a threshold, and determine whether a number of graph elements accessed in the simulated execution is greater than the threshold.

In an example, instructions 510 may send the query to a graph analytic query engine in the event that the number of graph elements is greater than the threshold, or may send the query to a graph navigation query engine in the event that the number of graph elements is less than the threshold.

Although the instructions of FIGS. 2-5 show a specific order of performance of certain functionalities, the instructions of FIGS. 2-5 are not limited to that order. For example, the functionalities shown in succession may be performed in a different order, may be executed concurrently or with partial concurrence, or a combination thereof.

All of the features disclosed in this specification, including any accompanying claims, abstract and drawings, and/or all of the elements of any method or process so disclosed, may be combined in any combination, except combinations where at least some of such features and/or elements are mutually exclusive.

What is claimed is:

1. A graph database management system, comprising:
a graph processor engine to receive a graph database update from an application;
a graph navigation query engine to access a real-time graph and process the graph database update on the real-time graph; and
a synchronization engine to extract changes from the real-time graph and process the changes to a historical graph accessible by a graph analytic query engine.

2. The system of claim 1, wherein the graph processor engine comprises a federation engine.

3. The system of claim 1, wherein the synchronization engine is further to process the changes to a derived graph.

4. The system of claim 3, wherein the derived graph is presented as an application-specific database view.

5. A method for managing a graph database, comprising:
receiving a graph query;
determining a graph query type; and
in the event that the graph query type is a navigational short query, accessing a real-time graph on a graph navigation query engine and processing the navigation short query, and
in the event that the graph query type is an analytical long query, accessing a historical graph on a graph analytic query engine and processing the analytical long query.

6. The method of claim 5, wherein receiving a graph query further comprises receiving a graph query from a unified application programming interface to receive navigational short queries and analytical long queries for a graph database.

7. The method of claim 5, wherein determining a graph query type by simulation of the graph query comprises executing the query on a small graph.

8. The method of claim 5, further comprising updating a derived graph based on a result of the graph query.

9. The method of claim 8, wherein the derived graph is presented as an application-specific database view.

10. The method of claim 5, wherein the analytical ng query is a mining query.

11. The method of claim 5, further comprising updating a relational database based on a result of the graph query.

12. An article comprising at least one non-transitory machine-readable storage medium comprising instructions executable by a processing resource of a graph database management system to:
simulate execution of a graph query;
fetch a threshold;
determine whether a number of graph elements accessed in the simulated execution is greater than the threshold; and
in the event that the number of graph elements is greater than the threshold, send the query to a graph analytic query engine, and
in the event that the number of graph elements is less than the threshold, send the query to a graph navigation query engine.

13. The article of claim 12, wherein the threshold is related to a proportion of graph elements accessed by a query.

14. The article of claim 12, wherein the graph elements are a plurality of graph nodes.

15. The article of claim 12, wherein the graph elements are a plurality of graph edges.
